(19) United States
(12) Patent Application Publication
(10) Pub. No.: US 2024/0189966 A1
(43) Pub. Date: Jun. 13, 2024

(54) APPARATUS, SYSTEM AND METHOD OF USING AN IMPROVED WRENCH

(71) Applicant: Grant T. Ingallinera, Glenview, IL (US)

(72) Inventor: Grant T. Ingallinera, Glenview, IL (US)

(21) Appl. No.: 18/080,053

(22) Filed: Dec. 13, 2022

(51) Int. Cl. B25B 13/46; B25B 13/10

(52) U.S. Cl. CPC B25B 13/463; B25B 13/107; B25B 13/467

(57) ABSTRACT

An apparatus, system and method comprising an improved wrench designed and configured for usage as a hand tool used to tighten or loosen a hexagonal bolt and/or nut is provided. More specifically, the present disclosure relates to an apparatus and method comprising an improved wrench configured to be used without any need to disengage and/or reengage the tool in order to execute its intended function. In addition, the present disclosure can also be categorized as a novel and improved ratcheting wrench having a series of pawls configured to slip past a gear in one direction and yet capture when rotated in the opposite direction.

### FIELD OF THE DISCLOSURE

The present disclosure generally relates to an apparatus, system and method comprising an improved wrench designed and configured for usage as a hand tool generally used to tighten or loosen a fastener (e.g., hexagonal bolt and/or nut or other fasteners). More specifically, the present disclosure relates to an apparatus, system and method comprising an improved wrench configured to be used without any need to disengage and/or reengage the tool in order to execute its intended function. In addition, the present disclosure can also be categorized as a novel and improved ratcheting wrench having a series of pawls configured to slip past a gear in one direction and yet capture when rotated in the opposite direction.

### BACKGROUND

The invention relates generally to open end wrenches for hex nut operation and, more particularly, but not by way of limitation, it relates to improvements in open end wrenches as well as socket type wrenches capable of retaining within the jaw opening a plurality of inserts which serve to adapt the wrench size for a plurality of nut sizes. In the field of wrenches, ratchet wrenches are well known. In general, such classes of wrench are adapted for turning hexagonal nuts/bolts, wherein the wrench jaw may be adapted with a plurality of metallic inserts of prescribed dimension which serve to adapt the wrench for operation in tightening or loosening any of a plurality of standardized nut sizes. Most ratchet wrenches utilize a socket, where the socket includes an opening formed in the shape of a specific fastener size; for example, a half inch hexagonal bolt or 12-point bolt head.

Ratchet wrenches are sold with a variety of sockets, each socket designed to fit a specific sized bolt or nut. The wrench generally includes a structure adapted to secure the socket to a ratchet mechanism such that a variety of sockets may be interchangeably attached to the wrench. Prior art and conventional ratchet wrenches and sockets have been standardized where the ratchet wrench includes a protruding shank that is ⅜ inch square and the socket has a ⅜ inch square opening to accommodate the shank. Other standard size ratchet wrench shanks can be ½ inch square with the sockets having corresponding ½ inch square openings or have other sized dimensions.

The prior art wrenches include a great many types and sizes of wrench design which serve to turn nuts of various configurations and sizes. In addition, the many wrench types have been adapted to include several different forms of adjustable features wherein a single wrench instrument can be adapted to fit a plurality of nut sizes. A well-known example of adjustable wrench is the adjustable open end wrench which utilizes a screw driven lower jaw structure to adapt the wrench jaw opening to whatever the turning operation is at hand or its intended function. However, prior art wrenches lack certain advantageous features and characteristics. For instance, conventional wrenches lack certain convenient features like having the wrench configured to be used without any need to disengage and/or reengage the tool in order to execute its intended function. Further, none of the prior art wrenches comprise pawls or a series of pawls configured to slip past a gear in one direction and yet capture when rotated in the opposite direction.

Therefore, there is a need for an improved apparatus and method comprising an improved wrench designed and configured for usage for a hand tool generally used to tighten or loosen a hexagonal bolt and/or nut. The present invention and the related disclosure is directed to a wrench which overcomes certain disadvantages of the prior art and conventional devices while maintaining their functional advantages. The improved wrench disclosed herein is a novel and non-obvious improvement over conventional wrenches currently available in the marketplace.

More particularly, the present invention is directed to an apparatus and a method of comprising an improved wrench designed and configured for usage as a hand tool generally used to tighten or loosen a hexagonal bolt and/or nut. The present disclosure further relates to an apparatus and method comprising an improved wrench configured to be used without any need to disengage and/or reengage the tool in order to execute its intended function. In addition, the present disclosure can also be categorized as a novel and improved ratcheting wrench having a series of pawls configured to slip past a gear in one direction and yet capture when rotated in the opposite direction.

### BRIEF SUMMARY OF THE INVENTION

Embodiments disclosed in the present disclosure provide an apparatus, method and system of using a novel and unique wrench for fastener engagement and disengagement procedures. The following presents a simplified summary of the invention in order to provide a basic understanding of some example aspects of the invention.

It is to be noted that the summary is not an extensive overview of the invention. Moreover, this summary is not intended to identify critical elements of the invention nor delineate the scope of the invention. The sole purpose of the summary is to present some concepts of the invention in simplified form as a prelude to the more detailed description that is presented later.

An apparatus, system and method comprising an improved tool/wrench is provided—the improved tool/wrench configured to be used in the field without the need to disengage and/or reengage the tool/wrench in order to execute its intended function. The improved tool/wrench comprises a main body having a handle with a head formed with an open end, the open end defining a longitudinal axis that extends therethrough. The improved tool/wrench head further includes a recess formed on an inner surface thereof. A ratchet member is configured to be seated in the recess for rotation about the longitudinal axis, wherein the ratchet member further comprises a radially extending outer surface that is generally parallel to the longitudinal axis. By way of example and not of limitation, the tool disclosed herein can be configured as a ratcheting wrench comprising a series of pawls; the pawls are further configured to slip past a gear in one direction and still catch when rotated in the opposite direction. It is to be noted that various uses of the apparatus, system and method disclosed herein would include a pipe union where under present circumstances only an open end wrench can be employed for the purpose of tightening or loosening the coupling. The use of the apparatus, system and method disclosed herein would help to reduce the time required to perform the intended function of a common open ended wrench.

The tool/wrench disclosed herein eliminates the need for individual wrenches to accommodate multiple sizes of fasteners. During operation/usage of the tool, the wrench engages the fastener (e.g., the nut/bolt) by sliding the open end of the wrench, with the ratcheting gear positioned as detailed and shown in the accompanying drawings of this disclosure. Once the nut/bolt is seated inside the open side of the hexagon of the ratcheting gear, the handle can be rotated in a counterclockwise direction around the center of the nut/bolt. As the handle is rotated counterclockwise, the gears allow the wrench to slide past the pawls. If the handle is rotated clockwise, the pawls will lock onto the ratcheting gear, thereby rotating the nut/bolt in a clockwise direction. The purpose of the retention ring is to maintain pressure on the pawls, so as to maintain contact with the ratcheting gear. One of the key aspects and novelty of this invention is the function of the retention ring; the retention ring is configured to and will yield to the pawls should a sufficient pressure be exerted by the gear in a counterclockwise direction, thereby allowing the wrench to rotate around the fastener while the fastener (e.g., the nut/bolt) remains stationary. Furthermore, various inserts can be added or removed from the wrench to accommodate various sizes and shapes of fasteners.

In another aspect of the present disclosure, the apparatus, system and method comprises an improved ratchet wrench (e.g., ratchet open wrench) comprising a main body having a handle with a head formed with an open end, the open end defining a longitudinal axis that extends therethrough. In the depicted embodiment, the head comprises a recess formed on an inner surface thereof wherein the head further includes a C-shaped first portion and an elongated second portion having a proximal end thereof disposed on and secured to an exterior surface of the C-shaped first portion. A ratchet member configured to be seated in the recess for rotation about the longitudinal axis, wherein the ratchet member further comprises a radially extending outer surface that is generally parallel to the longitudinal axis.

In the depicted embodiment, a plurality of pawls disposed circumferentially around the longitudinal axis within an aperture of the recess, wherein the pawls are further configured to be anchored by a plurality of pins encircling the tool head; a retention ring disposed circumferentially around the longitudinal axis within an aperture of the recess; and a gear disposed circumferentially around the longitudinal axis within an aperture of the recess and configured to engage a fastener. The improved ratchet open end wrench is configured such that (a) the plurality of pawls is further adapted to pivot relative to a certain orientation, the pawls being provided with a plurality of pawl teeth disposed for movement into and out of engagement with the ratchet teeth; (b) the plurality of pawls are further adapted to engage a fastener and continue to operate without the need to disengage and reengage with the fastener during operation; and (c) the plurality of pawls slip past the gear in a first direction and capture the gear when rotated in a second direction.

In another aspect of the present disclosure or in another embodiment, the wrench can be a standard C-shaped head wrench further comprising a plurality of springs abutting and engaging a predetermined portion of a pair of dogs. A generally C-shaped insert can be centrally disposed within the C-shaped portion of the head. The C-shaped insert has an inner surface thereof shaped and sized to engage a preselected nut fastener and a predetermined plurality of first ratchet teeth disposed radially on an outer surface thereof and operatively meshing with the predetermined plurality of second ratchet teeth disposed on the inner surface of each dog. An actuating member is supported on the generally C-shaped first portion and secured to the spring ends thereof. The actuating member is selectively operable to rotate the insert with the ratchet wrench in one rotational direction while ratcheting the ratchet wrench about the insert in an opposed rotational direction and rotating the insert with the ratchet wrench in the opposed rotational direction while ratcheting the ratchet wrench about the insert in the one rotational direction.

In another aspect of the present disclosure, an improved hand tool is configured to be a ratcheting open end/closed end wrench with removable inserts which can accommodate multiple sizes of bolts and/or nuts. A selected insert is received within a slot in the jaws of the wrench and the wrench further employs a series of pawls which slip past a gear in one direction, yet catch when rotated in the opposite direction, so that the bolt/nut may be rotated in a ratcheting action. In alternative embodiments, the hand tool falls within the category of a wrench, used to tighten or loosen a hexagonal bolt and/or nut. For instance, the invention disclosed herein can be configured as a category of speed wrench due to the rapid use of the tool without the need to disengage and reengage the tool in order to execute its intended function, and can also be categorized as a ratcheting wrench due to the fact that it employs a series of pawls which slip past a gear in one direction, yet catch when rotated in the opposite direction.

The disclosed apparatus, system and method allows a user to engage the fastener and continue to perform the function of tightening or loosening without the need to disengage, regardless of whether or not there is an obstruction impeding the rotation of the wrench a full 360 degrees. Furthermore, the invention combines and eliminates the need for both an open end and box end wrench and creates a ratcheting open end/closed end wrench with removable inserts which can accommodate multiple sizes of bolts and/or nuts.

In yet another aspect of the present disclosure or in another embodiment, a system of forming an improved wrench comprises: (1) a main body having a handle with a head formed with an open end, the open end defining a longitudinal axis that extends therethrough; (2) a ratchet member to be seated in the recess for rotation about the longitudinal axis, wherein the ratchet member further comprises a radially extending outer surface that is generally parallel to the longitudinal axis; (3) a plurality of pawls pivotably disposed circumferentially around the longitudinal axis within an aperture of the recess; the plurality of pawls further configured to slip past the gear in a first direction while capturing the gear when rotated in a second direction; (4) the plurality of pawls anchored by a plurality of pins encircling the tool head; (5) a retention ring disposed circumferentially around the longitudinal axis within an aperture of the recess; and (6) a gear disposed circumferentially around the longitudinal axis within an aperture of the recess. In the disclosed system, the plurality of pawls further adapted to pivot relative to a certain orientation, the plurality of pawls being provided with a plurality of pawl teeth disposed for movement into and out of engagement with the ratchet teeth; and wherein the plurality of pawls are further configured to engage a fastener and continue to operate without the need to disengage and reengage with the fastener during operation.

In another aspect of the present disclosure, a method of forming an improved wrench comprises the steps of (1) configuring a main body having a handle with a head formed with an open end, the open end defining a longitudinal axis that extends therethrough; (2) configuring a ratchet member to be seated in the recess for rotation about the longitudinal axis, wherein the ratchet member further comprises a radially extending outer surface that is generally parallel to the longitudinal axis; (3) pivotably disposing a plurality of pawls circumferentially around the longitudinal axis within an aperture of the recess; the plurality of pawls further configured to slip past the gear in a first direction while capturing the gear when rotated in a second direction; (4) configuring the pawls to be anchored by a plurality of pins encircling the tool head; (5) disposing a retention ring circumferentially around the longitudinal axis within an aperture of the recess; (6) disposing a gear circumferentially around the longitudinal axis within an aperture of the recess; and (7) configuring the pawl to be adapted to pivot relative to a certain orientation, the pawl being provided with a plurality of pawl teeth disposed for movement into and out of engagement with the ratchet teeth. In another aspect of the present disclosure, and by way of example and not of limitation, the use of this invention would help to reduce the time required to perform the intended function of a common open-ended wrench.

This summary is provided to introduce a selection of concepts in a simplified form that are further described in the detailed description of the disclosure. This summary is not intended to identify key or essential inventive concepts of the claimed subject matter, nor is it intended for determining the scope of the claimed subject matter. The references made above in detail to the embodiments of the disclosure are provided by way of explanation of the disclosure, not in limitation of the disclosure. It will be apparent to those skilled in the art that various modifications and variations can be made in the present disclosure without departing from the scope or spirit of the disclosure.

Features illustrated or described as part of one embodiment can be used on another embodiment to yield a still further embodiment. Thus, it is intended that the present disclosure cover such modifications and variations as come within the scope of the appended claims and their equivalents. Other objects, features and aspects of the present disclosure are disclosed in the following detailed description. It is to be understood by one of ordinary skill in the art that the present discussion is a description of exemplary embodiments only and is not intended as limiting the broader aspects of the present disclosure, which broader aspects are embodied in the exemplary constructions.

### BRIEF DESCRIPTION OF THE DRAWINGS

The disclosure will be more readily understood in view of the following description when accompanied by the below figures. The accompanying figures incorporated in and forming a part of the specification illustrate several aspects of the present invention and, together with the description, serve to explain the principles of the invention.

FIG. 1 illustrates an embodiment of the improved wrench according to one aspect of the present disclosure.

FIG. 2 illustrates an embodiment of the improved wrench including the pawls anchored by a pin and encircling the tool according to one aspect of the present disclosure.

FIG. 3 illustrates an embodiment of the improved wrench including the retention ring encircling the main body of the tool according to one aspect of the present disclosure.

FIG. 4 illustrates an embodiment of the improved wrench including the ratcheting gear which engages the fastener according to one aspect of the present disclosure.

FIGS. 5 and 6 illustrate an embodiment of the improved wrench including the retention ring encircling the main body of the tool according to one aspect of the present disclosure.

### DETAILED DESCRIPTION OF THE DISCLOSURE

For the purposes of promoting and understanding the principles disclosed herein, reference is now made to the preferred embodiments illustrated in the drawings, and specific language is used to describe the same. It is understood that no limitation of the scope of the disclosure is hereby intended. Such alterations and further modifications in the illustrated apparatus and such further applications of the principles disclosed and illustrated herein are contemplated as would normally occur to one of ordinary skill in the art to which this disclosure relates.

In an aspect of the present disclosure, an apparatus, system and method related to an improved tool/wrench which can be used in the field without the need to disengage and reengage the tool in order to execute its intended function is provided. The tool comprises a main body having a handle with a head formed with an open end, the open end defining a longitudinal axis that extends therethrough. The tool head further includes a recess formed on an inner surface thereof. A ratchet member is configured to be seated in the recess for rotation about the longitudinal axis, wherein the ratchet member further comprises a radially extending outer surface that is generally parallel to the longitudinal axis.

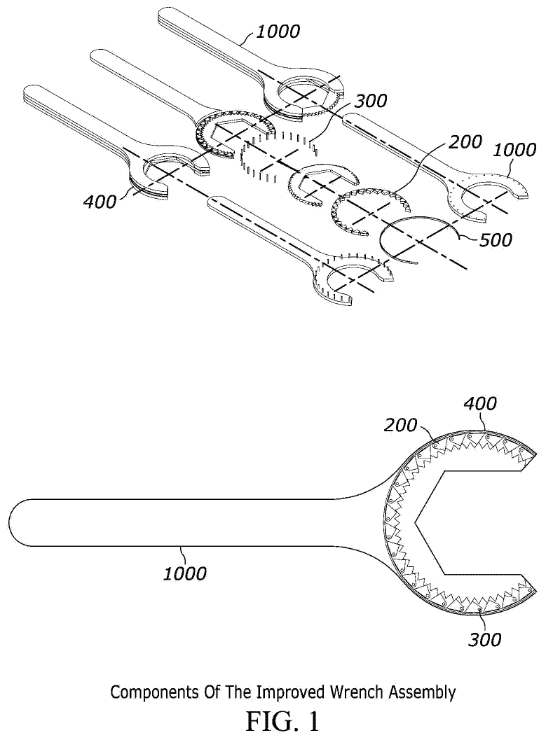

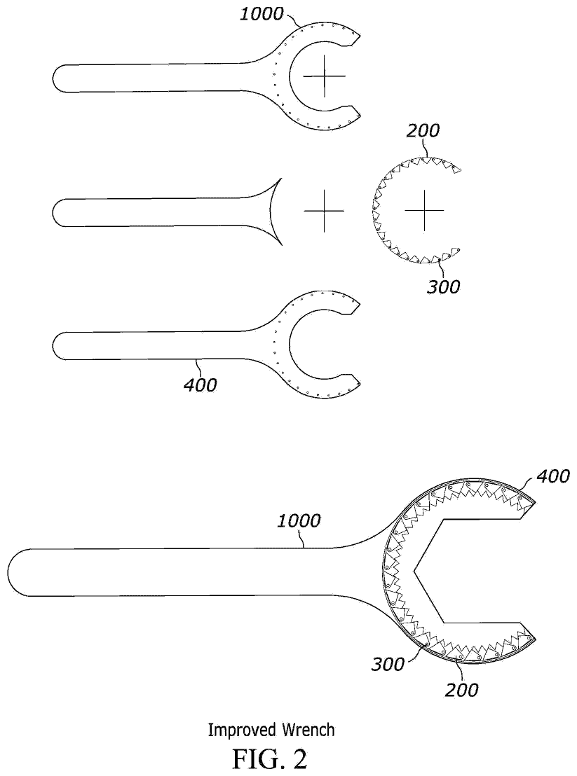

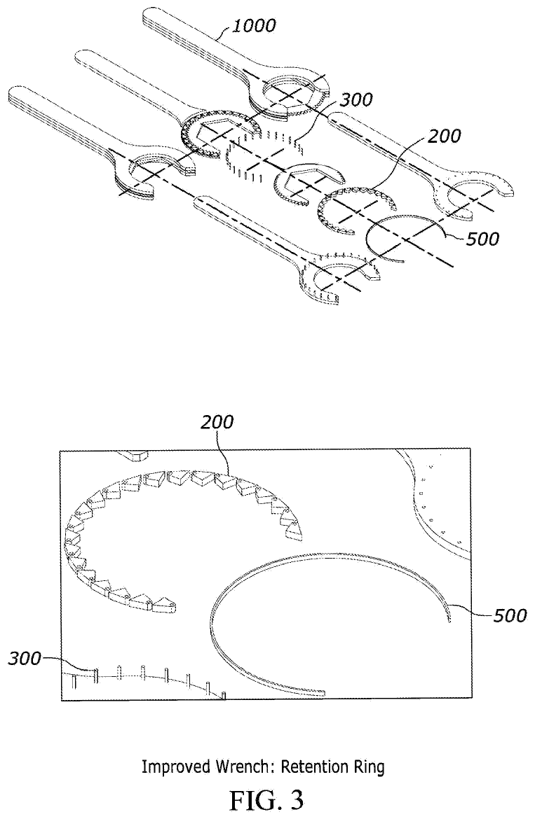

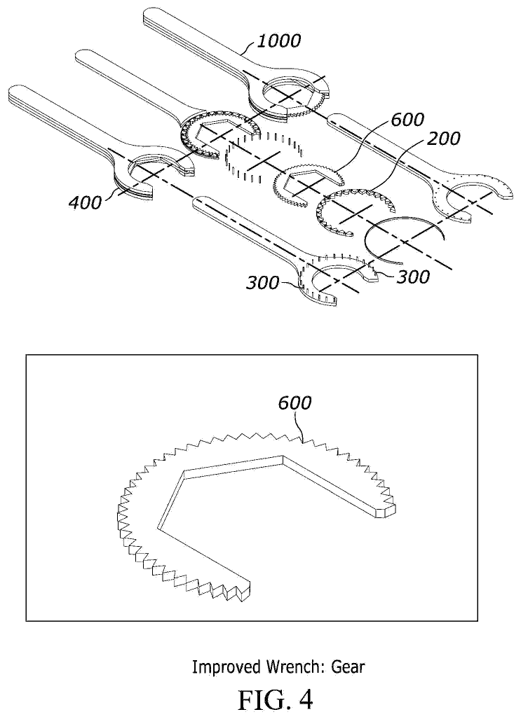

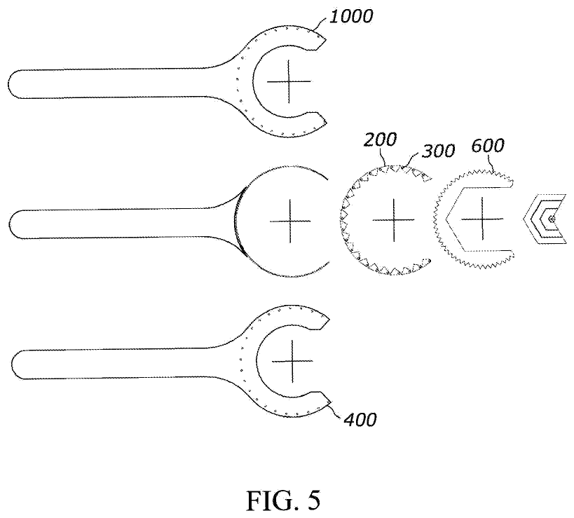

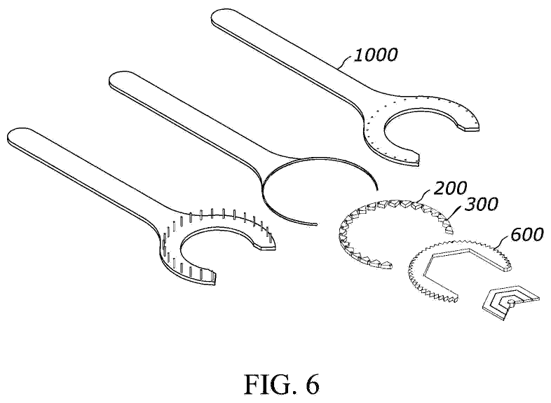

In another aspect of the present disclosure, as illustrated in FIGS. 1-4, an apparatus, system and method comprises an improved tool/wrench 1000 having a plurality of pawls 200 disposed circumferentially around the longitudinal axis within an aperture of the recess; the pawls 200 are further configured to be anchored by a plurality of pins 300 encircling the tool head 400. In alternative embodiments, the tool can be a wrench 1000 or other similar device providing equivalent functionality for fastener engagement and/or disengagement. In the depicted embodiment, by way of example and not of limitation, a retention ring 500 is disposed circumferentially around the longitudinal axis within an aperture of the recess of the wrench 1000. The wrench 1000 further includes a gear 600 disposed circumferentially around the longitudinal axis within an aperture of the recess and configured to engage a fastener (not shown for clarity).

In another aspect of the present disclosure, during operation of the tool/wrench 1000, the plurality of pawls 200 is further adapted to pivot relative to a certain orientation, the pawls 200 being provided with a plurality of pawl teeth 200a disposed for movement into and out of engagement with the ratchet teeth 700a. The pawls 200 are further configured to engage a fastener and continue to operate without the need to disengage and reengage with the fastener during operation of the tool/wrench 1000.

In yet another aspect of the present disclosure, the apparatus, system and method comprises a ratchet open wrench tool 1000 and having a head with a C-shaped first portion and an elongated second portion having a proximal end thereof disposed on and secured to an exterior surface of the C-shaped first portion. The pawls 200 are further configured to be anchored by a plurality of pins 300 disposed circumferentially around the longitudinal axis within an aperture of the recess and encircling the head. By way of example and not of limitation, in the depicted embodiment, the pawls 200 are further configured to slip past the gear when rotated in a first direction and yet capture the gear when rotated in a second direction. As illustrated in FIGS. 1-4, the following components—at a minimum—are part of the improved tool/wrench disclosed herein: (1) handle and body of wrench 1000; (2) pawls 200 which are anchored by pins 300 encircling the wrench 1000; (3) retention ring 500 encircling the main body of the tool/wrench 1000 and applying tension to the pawls 200; and (4) ratcheting gear 600 configured to engage the nut/bolt or other fasteners.

In another aspect of the present disclosure, the tool/wrench 1000 is further adapted to perform the function of tightening and/or loosening the fastener regardless of whether or not there is an obstruction impeding a full 360-degree rotation of the tool/wrench 1000. It is to be noted that the improved tool/wrench 1000 disclosed herein can be used—alternatively in certain embodiments—as an open end wrench 1000 and/or a box end wrench 1000. In various aspects and/or alternative embodiments the retention ring 500 can be made of spring steel (or other materials having similar strength and equivalent material characteristics in order to provide the novel functionality of the wrench 1000) and configured to align circumferentially with the main body of the tool and apply tension to the plurality of pawls 200.

The tool/wrench 1000 can further be configured as a ratcheting open end and/or ratcheting closed end wrench with removable inserts for accommodating multiple sizes of fasteners. One of the key aspects of the wrench 1000 disclosed herein is the ability of the pawls 200 to (a) engage a fastener and continue to operate without the need to disengage and reengage with the fastener during operation and (b) slip past the gear 600 in a first direction and yet capture when rotated in a second direction. The foregoing along with the various other innovative features, configurations and/or functional characteristics of the wrench, disclosed herein, further provides the innovative function of using the improved tool/wrench 1000 for tightening and/or loosening a fastener regardless of whether or not there is an obstruction impeding a full 360-degree rotation of the tool/wrench 1000.

In another aspect of the present disclosure, an improved wrench of the open end type, the wrench 1000 consists of a handle portion or an elongated shaft having a circular shaped flat portion or wrench end. Alternative suitable wrench heads may be disposed on each end of the elongated shaft. The wrench head may include polished, flat side surfaces (as disposed on each side of the wrench head), and further configured with a jaw (or seizing jaw). The jaw further includes an upper jaw portion and a lower jaw portion, each jaw portion having contacting surfaces generally aligned along the parallel inner sides of the upper jaw portion and lower jaw portion. In alternative embodiments, an inner jaw portion contiguous between the interior portions of upper and lower jaw portions can also be formed within the jaw configuration of the wrench 1000. The wrench head can be a variation of what is known as the ratchet-type open end wrench. In alternative embodiments, the jaw can be adapted to receive an insertable jaw spacer or adaptor insert which serves to adapt the jaw for certain configurations/sizes of hexagonal nuts/bolts. The improved wrench is further designed and configured for usage as a general hand tool used to tighten or loosen a hexagonal bolt and/or nut.

In another aspect of the present disclosure, a method of forming an improved wrench comprises the steps of (1) configuring a main body having a handle with a head formed with an open end, the open end defining a longitudinal axis that extends therethrough; (2) configuring a ratchet member to be seated in the recess for rotation about the longitudinal axis, wherein the ratchet member further comprises a radially extending outer surface that is generally parallel to the longitudinal axis; (3) pivotably disposing a plurality of pawls circumferentially around the longitudinal axis within an aperture of the recess; the plurality of pawls further configured to slip past the gear in a first direction while capturing the gear when rotated in a second direction; (4) configuring the pawls to be anchored by a plurality of pins encircling the tool head; (5) disposing a retention ring circumferentially around the longitudinal axis of the recess within an aperture of the recess; (6) disposing a gear circumferentially around the longitudinal axis within an aperture of the recess; and (7) configuring the pawl to be adapted to pivot relative to a certain orientation, the pawl being provided with a plurality of pawl teeth disposed for movement into and out of engagement with the ratchet teeth. In another aspect of the present disclosure, and by way of example and not of limitation, the use of this invention would help to reduce the time required to perform the intended function of a common open-ended wrench.

The preceding description is not meant to limit the scope of the disclosure but to provide sufficient disclosure to allow one of ordinary skill in the art to practice the disclosure without undue burden. It is further understood that the scope of the present disclosure fully encompasses other embodiments that may become obvious to those skilled in the art, and that the scope of the present disclosure is accordingly limited by nothing other than the appended claims. It is understood that the preceding is merely a detailed description of some examples and embodiments of the present disclosure, and that numerous changes to the disclosed embodiments may be made in accordance with the disclosure made herein without departing from the spirit or scope of the disclosure. All references, including publications, patent applications and patents cited herein, are hereby incorporated by reference to the same extent as if each reference were individually and specifically indicated to be incorporated by reference and were set forth in its entirety herein.

The use of the terms “a,” “an,” “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein.

The methods described and disclosed herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed.

It is understood that the preceding is merely a detailed description of some examples and embodiments of the present disclosure, and that numerous changes to the disclosed embodiments may be made in accordance with the disclosure made herein without departing from the spirit or scope of the disclosure. The preceding description, therefore, is not meant to limit the scope of the disclosure, but to provide sufficient disclosure to allow one of ordinary skill in the art to practice the disclosure without undue burden.

It is further understood that the scope of the present disclosure fully encompasses other embodiments that may become obvious to those skilled in the art. Features illustrated or described as part of one embodiment can be used in another embodiment to yield a still further embodiment. Thus, it is intended that the present disclosure cover such modifications and variations as come within the scope of the appended claims and their equivalents. It is to be understood by one of ordinary skill in the art that the present discussion is a description of exemplary embodiments only, and is not intended as limiting the broader aspects of the present disclosure, which broader aspects are embodied in the exemplary constructions.

The terms “invention,” “the invention,” “this invention,” “the present invention,” “disclosure,” “the disclosure” and “the present disclosure” used in this patent are intended to refer broadly to all of the subject matter of this patent and the patent claims below. Statements containing these terms should be understood not to limit the subject matter described herein or to limit the meaning or scope of the patent claims below. Embodiments of the invention covered by this patent are defined by the claims below. This specification is a high-level overview of various aspects of the invention and introduces some of the concepts that are further described in the detailed description. This specification is not intended to identify key or essential features of the claimed subject matter, nor is it intended to be used in isolation to determine the scope of the claimed subject matter. The subject matter should be understood by reference to appropriate portions of the entire specification of this patent, any or all drawings and each claim. Although the present disclosure and its advantages have been described in detail, it should be understood that various changes, substitutions and alterations can be made herein without departing from the spirit and scope of the disclosure as defined in the appended claims.

1. A tool comprising:
a main body having a handle with a head formed with an open end, the open end defining a longitudinal axis that extends therethrough;
the head comprising a recess formed on an inner surface thereof;
a ratchet member configured to be seated in the recess for rotation about the longitudinal axis, wherein the ratchet member further comprises a radially extending outer surface that is generally parallel to the longitudinal axis;
a plurality of pawls disposed circumferentially around the longitudinal axis within an aperture of the recess;
a retention ring disposed circumferentially around the longitudinal axis within an aperture of the recess;
a gear disposed circumferentially around the longitudinal axis within an aperture of the recess and configured to engage a fastener;
wherein the plurality of pawls is further adapted to pivot relative to a certain orientation, the plurality of pawls being provided with a plurality of pawl teeth disposed for movement into and out of engagement with the ratchet teeth; and
wherein the plurality of pawls are further configured to engage a fastener and continue to operate without the need to disengage and reengage with the fastener during operation of the tool.

2. The tool of claim 1, wherein the tool is a ratchet open wrench tool and wherein the head further includes a C-shaped first portion and an elongated second portion having a proximal end thereof disposed on and secured to an exterior surface of the C-shaped first portion.

3. The tool of claim 2, wherein the pawls are further configured to be anchored by a plurality of pins disposed circumferentially around the longitudinal axis within an aperture of the recess and encircling the head.

4. The tool of claim 1, wherein the pawls are further configured to slip past the gear when rotated in a first direction and capture the gear when rotated in a second direction.

5. The tool of claim 1, wherein the tool is further adapted to perform the function of tightening and/or loosening a fastener regardless of whether or not there is an obstruction impeding a full 360-degree rotation of the tool.

6. The tool of claim 1, wherein the tool can be used as an open end wrench and/or a box end wrench.

7. The tool of claim 1, wherein the retention ring is made of spring steel and configured to align circumferentially with the main body of the tool and apply tension to the plurality of pawls.

8. The tool of claim 1, wherein the tool further comprises a ratcheting open end and/or ratcheting closed end wrench with removable inserts for accommodating multiple sizes of fasteners.

9. An improved ratchet wrench comprising:
a main body having a handle with a head formed with an open end, the open end defining a longitudinal axis that extends therethrough;
wherein the head comprises a recess formed on an inner surface thereof;
wherein the head further includes a C-shaped first portion and an elongated second portion having a proximal end thereof disposed on and secured to an exterior surface of the C-shaped first portion;
a ratchet member configured to be seated in the recess for rotation about the longitudinal axis, wherein the ratchet member further comprises a radially extending outer surface that is generally parallel to the longitudinal axis;
a plurality of pawls disposed circumferentially around the longitudinal axis within an aperture of the recess;
a retention ring disposed circumferentially around the longitudinal axis within an aperture of the recess;
a gear disposed circumferentially around the longitudinal axis within an aperture of the recess and configured to engage a fastener;
wherein the plurality of pawls are further adapted to pivot relative to a certain orientation, the pawls being provided with a plurality of pawl teeth disposed for movement into and out of engagement with the ratchet teeth; and
wherein the plurality of pawls are further configured to engage a fastener and continue to operate without the need to disengage and reengage with the fastener during operation.

10. The improved ratchet wrench of claim 9, wherein the pawls are further configured to be anchored by a plurality of pins disposed circumferentially around the longitudinal axis within an aperture of the recess and encircling the head.

11. The improved ratchet wrench of claim 9, wherein the pawls are further configured to slip past the gear when rotated in a first direction and capture the gear when rotated in a second direction.

12. The improved ratchet wrench of claim 9, wherein the wrench is further adapted to perform the function of tightening and/or loosening the fastener regardless of whether or not there is an obstruction impeding a full 360-degree rotation of the tool.

13. The improved ratchet wrench of claim 9, wherein the wrench can be an open end wrench and/or a box end wrench.

14. The improved ratchet wrench of claim 9, wherein the retention ring is made of spring steel and configured to align circumferentially with the main body of the tool and apply tension to the plurality of pawls.

15. The improved ratchet wrench of claim 9, wherein the tool further comprises a ratcheting closed end wrench with removable inserts for accommodating multiple sizes of fasteners.

16. A method of forming an improved wrench, the method comprising the steps of:
configuring a main body having a handle with a head formed with an open end, the open end defining a longitudinal axis that extends therethrough;
configuring a ratchet member to be seated in the recess for rotation about the longitudinal axis, wherein the ratchet member further comprises a radially extending outer surface that is generally parallel to the longitudinal axis;
pivotably disposing a plurality of pawls circumferentially around the longitudinal axis within an aperture of the recess; the plurality of pawls further configured to slip past the gear in a first direction while capturing the gear when rotated in a second direction;
configuring the plurality of pawls to be anchored by a plurality of pins encircling the tool head;
disposing a retention ring circumferentially around the longitudinal axis within an aperture of the recess;
disposing a gear circumferentially around the longitudinal axis within an aperture of the recess; and
configuring the plurality of pawls to be adapted to pivot relative to a certain orientation, the plurality of pawls being provided with a plurality of pawl teeth disposed for movement into and out of engagement with the ratchet teeth.

17. The method of claim 16, further comprising the steps of:
engaging a fastener and continuing to operate the tool without the need to disengage and reengage with the fastener during operation.

18. The method of claim 16, wherein the wrench is a ratchet open wrench tool and wherein the head further includes a C-shaped first portion and an elongated second portion having a proximal end thereof disposed on and secured to an exterior surface of said C-shaped first portion.

19. The method of claim 16, wherein the tool is further configured to perform the function of tightening and/or loosening the fastener regardless of whether or not there is an obstruction impeding the full 360-degree rotation of the tool.

20. The method of claim 16, wherein the tool can be used as an open end wrench and/or a box end wrench.

21. The method of claim 16, wherein the retention ring is made of spring steel and configured to align circumferentially with the main body of the tool and apply tension to the plurality of pawls.

22. The method of claim 16, wherein the tool further comprises a ratcheting open end and/or ratcheting closed end wrench with removable inserts for accommodating multiple sizes of fasteners.

23. A method of using an improved wrench, the method comprising the steps of:
sliding an open end of the wrench having a tool handle and a plurality of pawls along with a ratcheting gear;
positioning the open end of the wrench in proximity to a fastener in order to engage with the fastener;
positioning the fastener to be seated inside the open side of the hexagon of the ratcheting gear;
moving the wrench in a sliding motion past the plurality of pawls;
configuring the tool handle to be rotated in a counterclockwise direction around a longitudinal axis running centrally through the fastener;
configuring a tool handle to be rotated in a clockwise direction around a longitudinal axis running centrally through the fastener;
capturing and locking the plurality of pawls into the ratcheting gear; and
rotating the fastener in a clockwise direction.

24. The method of claim 23, further comprising the steps of:
engaging a fastener and continuing to operate the tool without the need to disengage and reengage with the fastener during operation.

25. The method of claim 23, wherein the wrench is a ratchet open wrench tool and wherein the head further includes a C-shaped first portion and an elongated second portion having a proximal end thereof disposed on and secured to an exterior surface of said C-shaped first portion.

26. The method of claim 23, wherein the tool is further configured to perform the function of tightening and/or loosening the fastener regardless of whether or not there is an obstruction impeding the full 360-degree rotation of the tool.

27. The method of claim 23, wherein the tool can be used as an open end wrench and/or a box end wrench.

28. The method of claim 23, wherein the retention ring is made of spring steel and configured to align circumferentially with the main body of the tool and apply tension to the plurality of pawls.

29. The method of claim 23, wherein the tool further comprises a ratcheting open end and/or ratcheting closed end wrench with removable inserts for accommodating multiple sizes of fasteners.

30. A system of forming an improved wrench, the system comprising:
a main body having a handle with a head formed with an open end, the open end defining a longitudinal axis that extends therethrough;
a ratchet member to be seated in the recess for rotation about the longitudinal axis, wherein the ratchet member further comprises a radially extending outer surface that is generally parallel to the longitudinal axis;
a plurality of pawls pivotably disposed circumferentially around the longitudinal axis within an aperture of the recess; the plurality of pawls further configured to slip past the gear in a first direction while capturing the gear when rotated in a second direction;
the plurality of pawls anchored by a plurality of pins encircling the tool head;
a retention ring disposed circumferentially around the longitudinal axis within an aperture of the recess;
a gear disposed circumferentially around the longitudinal axis within an aperture of the recess; and
the plurality of pawls further adapted to pivot relative to a certain orientation, the plurality of pawls being provided with a plurality of pawl teeth disposed for movement into and out of engagement with the ratchet teeth; and
wherein the plurality of pawls are further configured to engage a fastener and continue to operate without the need to disengage and reengage with the fastener during operation.
